(19) United States
(12) Patent Application Publication
(10) Pub. No.: US 2014/0168497 A1
(43) Pub. Date: Jun. 19, 2014

(54) CAMERA MODULE DRIVER AND CAMERA MODULE INCLUDING THE SAME

(71) Applicant: SAMSUNG ELECTRO-MECHANICS CO., LTD., Suwon (KR)

(72) Inventors: Hoon Heo, Suwon (KR); Yong Joon Park, Suwon (KR); Jung Wook Hwang, Suwon (KR)

(73) Assignee: SAMSUNG ELECTRO-MECHANICS CO., LTD., Suwon (KR)

(21) Appl. No.: 14/081,846

(22) Filed: Nov. 15, 2013

(30) Foreign Application Priority Data
Dec. 17, 2012 (KR) 10-2012-0147447

(51) Int. Cl. H04N 5/232; H04N 5/225

(52) U.S. Cl. CPC H04N 5/23241; H04N 5/2254; H04N 5/2257
USPC 348/335; 348/372

(57) ABSTRACT

There are provided a camera module driver and a camera module including the same. The camera module driver includes: a driving unit driving a lens; and a memory unit storing an operation setting value of the driving unit, wherein the driving unit includes a register sensing application of power to perform a reset operation of changing arbitrarily distributed data into preset default data, and the driving unit and the memory unit are formed in a single integrated circuit.

### CROSS-REFERENCE TO RELATED APPLICATION

This application claims the benefit of Korean Patent Application No. 10-2012-0147447 filed on Dec. 17, 2012, with the Korean Intellectual Property Office, the disclosure of which is incorporated herein by reference.

### BACKGROUND

The present disclosure relates to a camera module driver capable of performing a reset operation by sensing application of a power, and a camera module including the same.

In addition to a camera and a video device that have been generally used as an image device, a camera module has been recently mounted in a portable terminal. The camera module is provided with a lens, a driver integrated circuit (IC) driving the lens, and the like. In the case in which a memory storing an operation setting value of the driver IC is present in the driver IC, after a power is applied to the camera module, the driver IC loads the operation setting value stored in the memory to a register to drive the lens.

In the case in which the power is applied, arbitrarily distributed data are present in the register. However, when the arbitrarily present data are not reset to default data before the register in which the arbitrarily distributed data are present loads the operation setting value stored in the memory, a malfunction may occur due to the arbitrarily distributed data.

The following Related Art Document (Patent Document 1), which relates to an apparatus for image processing and a method for initializing image processing, discloses that an image signal processor controlling a camera module loads characteristic values to perform initialization, but does not disclose setting a register in a driver IC to a default value before the initialization.

### Related Art Document

(Patent Document 1) Korean Patent Laid-Open Publication No. 2009-0112381

### SUMMARY

An aspect of the present disclosure may provide a camera module driver capable of resetting data arbitrarily distributed in a register to default data before loading an operation setting value by sensing application of a power, and a camera module including the same.

According to an aspect of the present disclosure, a camera module driver may include a driving unit driving a lens; and a memory unit storing an operation setting value of the driving unit, wherein the driving unit includes a register sensing application of a power to perform a reset operation of changing arbitrarily distributed data into preset default data, and the driving unit and the memory unit are formed in a single integrated circuit.

The register may load the operation setting value after performing the reset operation.

According to another aspect of the present disclosure, a camera module may include a lens; a camera module driver including a driving unit driving the lens and a memory unit storing an operation setting value of the driving unit; and a controlling unit providing a control signal to the driving unit to adjust a position of the lens, wherein the driving unit includes a register sensing application of a power to perform a reset operation of changing arbitrarily distributed data into preset default data, and the driving unit and the memory unit are formed in a single integrated circuit.

The register may load the operation setting value after performing the reset operation.

The controlling unit may provide the control signal to the driving unit after the register loads the operation setting value.

The controlling unit may include at least one of a microcontroller unit (MCU), an image signal processor (ISP), and an application processor (AP).

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram showing a camera module driver according to an exemplary embodiment of the present disclosure; and

FIG. 2 is a block diagram showing a camera module according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

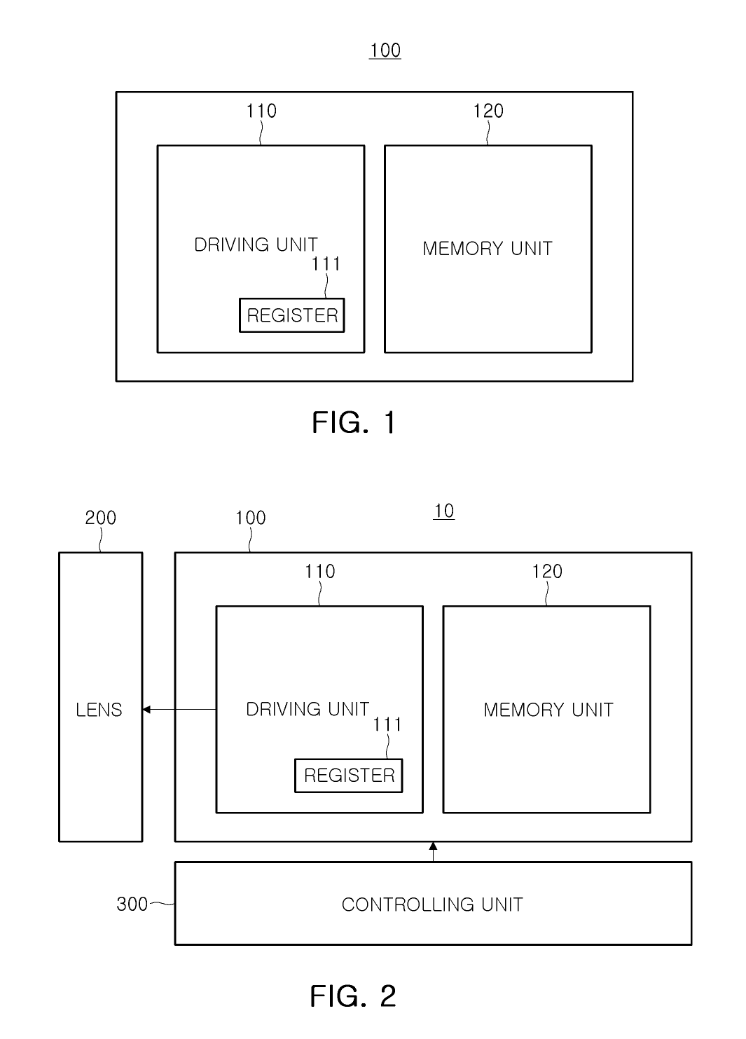

FIG. 1 is a block diagram showing a camera module driver according to an embodiment of the present disclosure. Referring to FIG. 1, a camera module driver 100 according to the embodiment of the present disclosure may include a driving unit 110 and a memory unit 120. The respective elements are divided based on roles thereof for each main unit and need not to be actually separated from each other in terms of hardware. In accordance with development of a technology, a plurality of elements may be configured in a single integrated circuit. As an example, the driving unit 110 and the memory unit 120 may be implemented in a single integrated circuit.

The driving unit 110 may drive a lens included in the camera module and include a register 111.

The memory unit 120 may store an operation setting value of the driving unit 110. The operation setting value may indicate a preset value for an operation of the driving unit 110 and include a process characteristic value of the camera module, a compensation value for compensating for the process characteristic value, a setting value of a driving signal used for the driving unit 110 to drive the lens, and the like.

Generally, in the case in which power is applied, data are arbitrarily distributed in a register used in a driver integrated circuit (IC). The register 111 according to the embodiment of the present disclosure may sense application of the power to perform a reset operation of changing the arbitrarily distributed data into preset default data.

The preset default data may be present in the register 111 performing the reset operation, and the register 111 may load the operation setting value from the memory unit 120 after performing the reset operation.

In the case in which the power is applied, the register 111 may sense the application of the power to change the arbitrarily distributed data into the preset default data and then load the operation setting value from the memory unit 120, thereby removing a malfunction that may occur when the driving unit 110 subsequently drives the lens.

FIG. 2 is a block diagram showing a camera module according to an exemplary embodiment of the present disclosure. Referring to FIG. 2, a camera module 10 according to the embodiment of the present disclosure may include the camera module driver 100, a lens 200, and a controlling unit 300.

Since the camera module driver 100 of FIG. 2 is the same as the camera module driver 100 of FIG. 1, a detailed description thereof will be omitted.

The lens 200 is driven by the camera module driver 100, such that a position of the lens 200 may be adjusted. Although not shown in FIG. 2, the camera module driver 100 may drive a coil disposed outside the lens 200 to adjust the position of the lens 200.

The controlling unit 300 may provide a control signal to the driving unit 110 to control the driving unit 110 to adjust the position of the lens. Here, the controlling unit 300 may include at least one of a micro computer unit (MCU), an image signal processor (ISP), and an application processor (AP).

As set forth above, according to exemplary embodiments of the present disclosure, the application of power is sensed to reset data arbitrarily distributed in a register to default data before the register loads the operation setting value, whereby a malfunction of a camera module may be prevented.

While exemplary embodiments have been shown and described above, it will be apparent to those skilled in the art that modifications and variations could be made without departing from the spirit and scope of the present disclosure as defined by the appended claims.

What is claimed is:

1. A camera module driver, comprising:
a driving unit driving a lens; and
a memory unit storing an operation setting value of the driving unit,
wherein the driving unit includes a register sensing application of power to perform a reset operation of changing arbitrarily distributed data into preset default data, and
the driving unit and the memory unit are formed in a single integrated circuit.

2. The camera module driver of claim 1, wherein the register loads the operation setting value after performing the reset operation.

3. A camera module comprising:
a lens;
a camera module driver including a driving unit driving the lens and a memory unit storing an operation setting value of the driving unit; and
a controlling unit providing a control signal to the driving unit to adjust a position of the lens,
wherein the driving unit includes a register sensing application of power to perform a reset operation of changing arbitrarily distributed data into preset default data, and
the driving unit and the memory unit are formed in a single integrated circuit.

4. The camera module of claim 3, wherein the register loads the operation setting value after performing the reset operation.

5. The camera module of claim 4, wherein the controlling unit provides the control signal to the driving unit after the register loads the operation setting value.

6. The camera module of claim 3, wherein the controlling unit includes at least one of a microcontroller unit (MCU), an image signal processor (ISP), and an application processor (AP).
